(19) United States
(12) Patent Application Publication
(10) Pub. No.: US 2026/0213788 A1
(43) Pub. Date: Jul. 23, 2026

(54) UTILIZING CONDITIONAL GENERATIVE ADVERSARIAL NETWORK-BASED COMPUTE FOR INTERFERENCE MITIGATION IN RECONFIGURABLE INTELLIGENT SURFACE-ASSISTED COMMUNICATION NETWORKS

(71) Applicant: Dell Products L.P., Round Rock, TX (US)

(72) Inventors: Tejinder Singh, Manotick (CA); Navjot Kaur Khaira, Manotick (CA); Seán Ahearne, Cork (IE)

(21) Appl. No.: 19/030,445

(22) Filed: Jan. 17, 2025

(51) Int. Cl. H04B 7/04; H04B 1/12

(52) U.S. Cl. CPC H04B 7/04013; H04B 1/12

(57) ABSTRACT

Example embodiments and implementations of the technology described herein are generally directed towards integrating a neural processing unit (NPU) within the controller chip of a high-frequency (e.g., millimeter wave or terahertz (THz)) reconfigurable intelligent surface (RIS). The RIS controller and NPU manages RIS functions for signal control and communication management between access points and client devices by leveraging the computational power and efficiency of NPUs, e.g., by running artificial intelligence models directly on-site with the RIS controller. Other example embodiments and implementations of the technology described herein are generally directed towards a high-frequency (e.g., THz) communication system that reduces interference and noise in high-frequency wireless networks utilizing AI-driven optimization. A conditional generative adversarial network (cGAN) performs real-time signal processing to modify signals by removing unwanted signal portions, determined via AI-based mapping to a predicted cancelation signal, to improve the signal quality of signals redirected by an RIS.

### RELATED APPLICATION

The subject patent application is related to U.S. Patent Application No. ______, filed ______, and entitled “INTEGRATED NEURAL PROCESSING UNIT FOR SIGNAL CONTROL AND COMMUNICATION MANAGEMENT IN RECONFIGURABLE INTELLIGENT SURFACES,” (docket no. 139555.01/DELLP1415US), the entirety of which patent application is hereby incorporated by reference herein.

### BACKGROUND

Reconfigurable intelligent surfaces (alternatively referred to metasurfaces) are man-made thin reflective or refractive surfaces whose electromagnetic response can be electronically controlled. Reconfigurable intelligent surfaces are characterized by their two-dimensional arrays of electronically controllable reflecting elements that can dynamically manipulate electromagnetic waves by altering attributes such as phase, amplitude, and direction of the incoming signal.

Each metasurface typically is made up of (possibly up to) dozens, hundreds, or thousands of unit-cells, and because the individual unit-cell can be controlled, reconfigurable intelligent surfaces can provide programmable and smart wireless environments. For example, one scenario is to use such a surface to intelligently reconfigure wireless communications. More particularly, objects in the path of a wireless signal, such as buildings and trees, can block wireless communication signals at higher frequencies, including millimeter-wave frequency bands and even higher (terahertz frequencies). A relatively inexpensive metasurface can be installed at various locations to reflect and/or refract higher frequency signals to otherwise blocked or weak coverage areas.

### BRIEF DESCRIPTION OF THE DRAWINGS

The technology described herein is illustrated by way of example and not limited in the accompanying figures in which like reference numerals indicate similar elements and in which:

FIG. 1 is a representation of an example communication network that includes a neural processing unit (NPU) integrated with a reconfigurable intelligent surface (RIS) controller, in accordance with various example embodiments and implementations of the subject disclosure.

FIG. 2 is an example representation of an RIS access point, in which integrated circuitry includes an NPU coupled to an RIS controller in a chip, in accordance with various example embodiments and implementations of the subject disclosure.

FIG. 3 is a representation of an example use case showing collaboration between NPU-integrated RIS controller access points for mobility tracking, in accordance with various example embodiments and implementations of the subject disclosure.

FIG. 4 is a representation of an example outdoor scenario in which some signals from a base station are blocked by obstacles, and are steered around the obstacles by controlled, dynamically adjusted reconfigurable intelligent surfaces (RISs) for consistent service quality, in accordance with various example embodiments and implementations of the subject disclosure.

FIG. 5 is a representation of models within network equipment and a user equipment (endpoint agent) that can be used to reconfigure an RIS, in accordance with various example embodiments and implementations of the subject disclosure.

FIG. 6 is a representation of models functionality layers associated with an RIS controller, in accordance with various example embodiments and implementations of the subject disclosure.

FIG. 7 is an exploded view representation of a subarray of unit cells of a reconfigurable intelligent surface showing a stack of layers of the subarray, in accordance with various example embodiments and implementations of the subject disclosure.

FIG. 8 is a block diagram representation of example components of subarrays of unit cells of a reconfigurable intelligent surface, in accordance with various example embodiments and implementations of the subject disclosure.

FIG. 9 is a three-dimensional (3D) perspective view representation of an example reconfigurable intelligent surface transmitting (reflecting) a nonmodified signal (with distortion and initially reflected as an uncorrected signal) as a beamformed beam, in accordance with various example embodiments and implementations of the subject disclosure.

FIG. 10 is a (3D) representation of the example reconfigurable intelligent surface determining and identifying interference in the incident wave, followed by filtering the signal into a filtered signal portion and an unwanted signal portion, in accordance with various example embodiments and implementations of the subject disclosure.

FIG. 11 is a (3D) representation of the example reconfigurable intelligent surface reducing interference via AI-based EM manipulation with distortion cancellation, along with absorbing the unwanted signal potion's energy and amplifying the filtered signal portion with reduced or eliminated interference, in accordance with various example embodiments and implementations of the subject disclosure.

FIG. 12 is a graphical representation of an example simulation of two GHz channels with 1 GHz bandwidth, having interference in adjacent channels, in accordance with various example embodiments and implementations of the subject disclosure.

FIG. 13 is a graphical representation of AI models identifying an offset signal (predicted cancelation signals) for the interference, in accordance with various example embodiments and implementations of the subject disclosure.

FIG. 14 is a graphical representation of a filtered clean signal after removing distortion via the offset signal of FIG. 13, in accordance with various example embodiments and implementations of the subject disclosure.

FIG. 15 is a sequence/dataflow diagram showing example interactions between various components, including to filter a signal for interference/noise/distortion, in accordance with various example embodiments and implementations of the subject disclosure.

FIG. 16 is an example representation of training a conditional generative adversarial network for filtering signals, in accordance with various example embodiments and implementations of the subject disclosure.

FIG. 17 is a flow diagram showing example operations related to obtaining signal modification data from a trained model, applying the signal modification data to modify incoming signals impinging on a reconfigurable intelligent surface, and communicating the modified signals via the reconfigurable intelligent surface to an endpoint device, in accordance with various example embodiments and implementations of the subject disclosure.

FIG. 18 is a flow diagram showing example operations related to obtaining predicted interference offset data from a generative adversarial network model, applying the predicted interference offset data to an incoming signal impinging on the reconfigurable intelligent surface to obtain a filtered signal, and redirecting the filtered signal to the endpoint device via the reconfigurable intelligent surface, in accordance with various example embodiments and implementations of the subject disclosure.

FIG. 19 is a flow diagram showing example operations related to obtaining and applying different signal correction data based on different incoming signals, to obtain different corrected signals for redirecting to an endpoint device via a reconfigurable intelligent surface, in accordance with various example embodiments and implementations of the subject disclosure.

### DETAILED DESCRIPTION

Example embodiments and implementations of the technology described herein are generally directed towards integrating a neural processing unit (NPU) within the controller chip of a high-frequency (e.g., millimeter wave or terahertz (THz)) reconfigurable intelligent surface (RIS), e.g., as part of a wireless access point. As will be understood, the integration can enhance signal control and communication management between access points and client devices by leveraging the computational power and efficiency of NPUs. Unlike traditional systems that rely on general-purpose CPUs, there can be a dedicated low-power NPU capable of performing complex signal processing tasks in real-time. For example, by embedding the NPU into a silicon chip that forms part of a radio unit (RU) (3GPP style architecture) or access point (AP) (IEEE style architecture), the technology described herein facilitates significant improvements in the real-time optimization of digital signals and communication protocols for high-frequency communications, which often uses of RIS. This is highly beneficial for future dense wireless network environments, where the demand for high bandwidth, low latency, and efficient resource management of communications spectrum continues to grow. The integration also supports the dynamic adaptation of RIS functionalities to changing network conditions including changing user demand, resulting in higher data throughput, more stable connections, and energy-efficient operations.

Note that the current generation of RIS controllers relies heavily on general-purpose CPUs to perform complex functions such as beamforming, mobility tracking, and range estimation. These CPUs are often insufficient for handling the real-time processing demands of these tasks, particularly in low-power environments like wireless access points. This inadequacy leads to several issues, including that performance bottlenecks often arise as general-purpose CPUs in low-power environments struggle with the computational load for real-time RIS control, resulting in delays and inefficiencies. As network demands increase, these CPUs become overwhelmed with dealing with RIS control, leading to suboptimal performance. The inability to perform rapid and accurate beamforming, for instance, results in degraded signal quality, reduced network efficiency, and lower quality of service. High latency is another significant problem, as a CPU's inability to perform rapid calculations impacts the responsiveness of the network, leading to higher latency and degraded user experience. In scenarios implicating very fast (e.g., virtually immediate) signal adjustments, such as when users move or obstacles interfere with signal paths, the delay in processing can cause significant disruptions in connectivity. This is particularly problematic in applications using real-time data transmission, such as augmented reality (AR), virtual reality (VR), and industrial automation. Energy inefficiency is also a major issue, as general-purpose CPUs consume more power when tasked with complex signal processing, making them unsuitable for low-power applications. Wireless access points and other network devices that rely on these CPUs experience higher operational costs, higher cooling specifications or requirements, and in some use cases reduced battery life. This inefficiency is one barrier to the deployment of sustainable and energy-efficient THz RIS networks, particularly in remote or resource-constrained environments. Limited adaptability further exacerbates the problem. The static application-specific integrated circuit (ASIC) hardware nature of current solutions prevents dynamic adaptation to changing network conditions and user demands, resulting in suboptimal network performance. High-frequency RIS networks sometimes adjust parameters such as beam direction, power levels, and frequency allocation in real-time to maintain optimal performance. General-purpose CPUs lack the speed required to make these adjustments effectively, while ASICs lack the flexibility required to adapt to new RIS conditions, leading to poor user experiences and underutilized network resources.

Scalability challenges also arise as networks grow in size and complexity, in which the limitations of general-purpose CPUs become more pronounced. Managing multiple RIS units and ensuring coordinated signal optimization across a large network is a difficult task for CPUs designed for general tasks rather than specialized, high-speed processing. This scalability issue hampers the ability of current networks to expand and meet increasing user demands.

Thus, described herein is integrating an RIS controller with an NPU that utilizes AI models for managing RIS functions, which is efficient and adaptable. The integration of NPUs into RIS controllers overcomes a number of existing RIS-related challenges, by offering enhanced computational capabilities, real-time adaptability, energy efficiency, and cost-effective scalability.

Other example embodiments and implementations of the technology described herein are generally directed towards a high-frequency (e.g., THz) communication system designed to address the challenges of interference and noise in high-frequency wireless networks. As will be understood, one such system dynamically manipulates and optimizes high-frequency signals to improve quality and reduce interference. Utilizing AI-driven optimization (such as via an integrated NPU), including conditional generative adversarial networks (cGAN) for real-time signal processing and deep reinforcement learning (DRL) for system management, the technology described herein enhances signal integrity, maintains high data rates, and ensures low latency with AI processing on-site in an RIS controller.

In one implementation, a centralized controller trains a large language model (LLM) from on-site filtered data to ensure privacy and model accuracy. Additionally, one implementation includes a hardware-based reconfigurable intelligent surface (RIS) module that integrates signal processing capabilities. The technology described herein provides robust performance for next-generation wireless communication, overcoming various limitations, including those imposed by environmental factors.

It should be understood that any of the examples and/or descriptions herein are non-limiting. Thus, any of the embodiments, example embodiments, concepts, structures, functionalities, or examples described herein are non-limiting, and the technology may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics, and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” reconfiguration means selecting a more optimal configuration over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

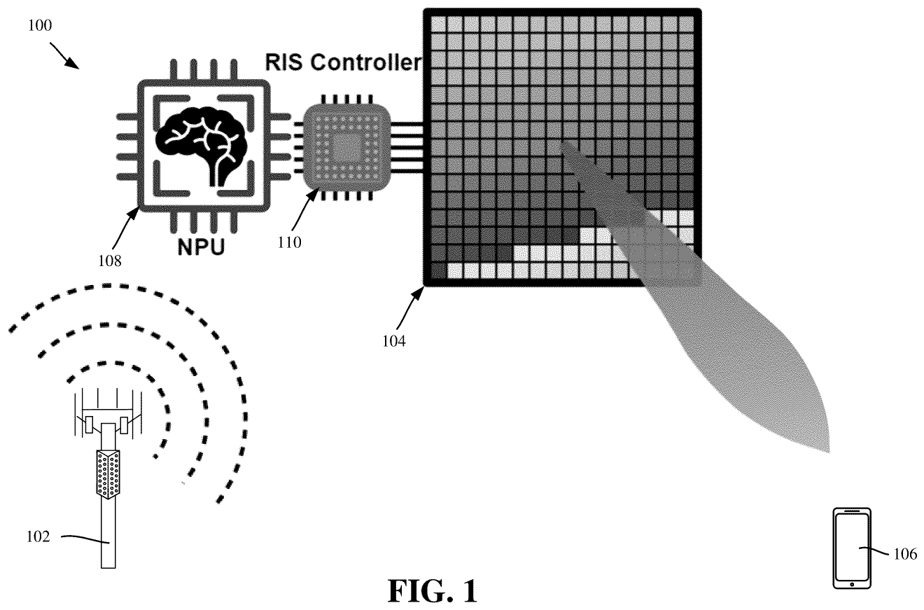

FIG. 1 is a conceptual depiction of a wireless communications environment including an example communications network/system 100 including a transmitter (e.g., base station) 102 that communicates via a reconfigurable intelligent surface (RIS) 104, with user equipment 106. In general, each of the reconfigurable intelligent surfaces 104(1) and 104(2), or metasurfaces, is a relatively large array of tunable elements that reflect incident waves with controllable phase and amplitude.

For millimeter wave or terahertz frequencies, the reconfigurable intelligent surface 104 may be used to avoid an obstacle between the base station 102 and the user equipment 106. In general, such high (e.g., THz) communication is blocked by many types of obstacles, whereby metasurface(s) can be used to avoid such obstacles that are between the transmitter and the receiver(s). Beams may bounce off multiple metasurfaces before reaching a receiver.

Described herein is integrating (e.g., embedding) a neural processing unit (NPU) 108 with an RIS controller chip 110 (integrated circuitry) on one or more devices to enhance real-time signal control and communication management. The NPU 108 is designed to utilize AI models for RIS operations, including determining RIS reconfiguration data. In general, an NPU can perform complex calculations and optimizations for RIS (such as beam steering) faster and more efficiently than general-purpose CPUs. Such NPUs are designed to handle AI workloads efficiently, providing the requested or necessary computational power for real-time optimization of RIS control functions. The integration of an NPU 108 with an RIS controller 110 can support various RIS control functions, significantly improving the overall performance and efficiency of the RIS network.

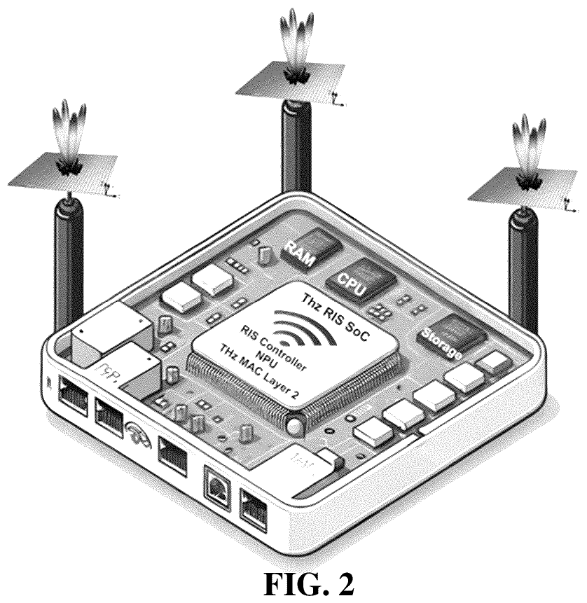

The design can include a low-power, high-performance NPU capable of handling real-time signal processing tasks. A conceptual diagram of one example design is shown in FIG. 2, depicting an RIS access point containing additional separate components such as CPU, RAM, and storage NAND flash. In this example, a high frequency (e.g., THz) system on chip (SoC) integrates the RIS controller and an NPU designed to handle the transmission of data at THz frequencies, interact with the RIS controller, with the NPU designed to accelerate RIS control functions, generally by executing one or more AI/ML models.

Candidates for the NPU-integrated devices can include adapting existing solutions, such as based on commercially available products with deep learning accelerators. An alternative solution is a custom-designed SoC with an embedded NPU tailored for specific RIS control functions. One type of integration involves embedding the selected NPU into the RIS controller chip, while another type of integration is to onboard the NPU on the same device as the controller. The design can ensure compatibility with the existing hardware (CPU, network controller, PCIe lanes, and the like), connected RIS and/or other antennae and wireless protocols, and seamless management of signal processing tasks. The design includes interfaces for the NPU 108 to interact with the RIS controller 110 and its input/output operations, such as from and to antennas and sensors, while maintaining power efficiency. Individual chips or a complete SoC can fully integrate into a wireless access point/radio unit with a similar overall look and feel to existing traditional wireless access point/radio unit.

Functionality enhancement is a general purpose of the integration, with the NPU 108 enabling several, generally advanced features. One of the example functions of the NPU 108 is to perform rapid beamforming calculations. By adjusting the phase and amplitude of the signals reflected or transmitted by the RIS 104, the NPU 108 can react to changes in the RIS 104 or the signal extremely quickly and can steer the beam towards the intended receiver 106, optimizing signal quality and coverage. This type of function involves complex matrix operations and optimization models that the NPU can handle efficiently.

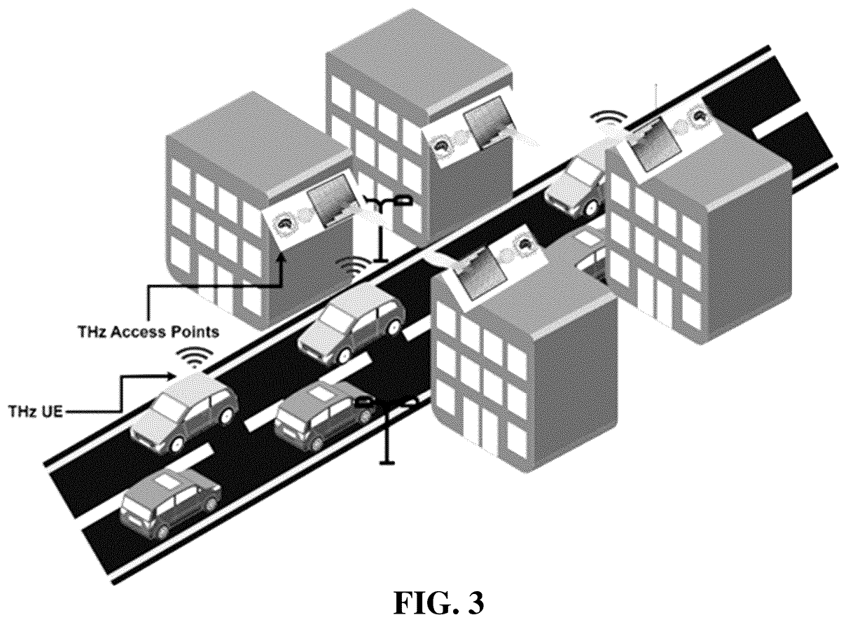

As another example, implementing AI models on the NPU allows for real-time mobility tracking. The NPU can continuously monitor the positions of user devices and can adjust signal parameters dynamically between moving objects to maintain optimal connectivity as users move through the network. This can include predicting user movements and preadjusting RIS configurations to help ensure uninterrupted connections. Accurate range estimation is another function supported by the NPU; by calculating the distance between the RIS and user devices, the NPU can optimize resource allocation and signal strength. This involves processing signal timing and strength data to determine the precise location of devices. FIG. 3 depicts an environment showing a use case including collaboration between NPU RIS AP's for mobility tracking.

Software development manages the NPU's interactions with the RIS hardware and other network components, along with firmware to control the NPU, ensuring real-time responsiveness and efficient use of the NPU's capabilities. The firmware facilitates the execution of AI models and handles tasks such as data collection, preprocessing, and communication with other network elements. The firmware can also enable future updates to the NPU models to be provided to the device over time. Implementing AI models tailored for signal optimization, mobility tracking, and other control functions is appropriate for leveraging the NPU's capabilities. Models can be optimized to run efficiently on the NPU, taking advantage of the NPU's parallel processing capabilities. Examples include deep learning models for beamforming optimization, reinforcement learning for mobility tracking, and machine learning models for range estimation.

Integration with network management systems is also facilitated, as the NPU-enhanced RIS controller can integrate seamlessly with existing network management systems, including compatibility with both 3GPP and IEEE standards. This allows the technology to serve as a radio unit or access point. The system can support both centralized and distributed control architectures. In centralized control, the RIS controllers, including the RIS controller 110 of FIG. 1, communicate with a central management unit that oversees network-wide optimization. In distributed control, each RIS controller operates autonomously, coordinating with neighboring units to optimize local performance. An example of an IEEE distributed architecture use case can be seen in FIG. 3, where NPU-enabled RIS AP's can collaborate with each other as part of a mesh network to communicate RIS performance statistics and mobile UE information between each other in real-time. Doing so with the real-time performance afforded by the NPU to process that information can greatly enhance network performance for connected UE's with high data-rate requirements or specifications (e.g., for autonomous vehicles, or factory floor mobile robotics).

To summarize thus far, AI capabilities can be directly coupled to (integrated with) an RIS controller. In one example, implementation, the AI model-execution capabilities can be integrated into an RIS controller chip through an embedded NPU. The integrated NPU enables real-time optimization of digital signals and communication protocols, a capability that general-purpose CPUs in low-power applications cannot match. This ensures that a high frequency (e.g., millimeter wave or THz) RIS network can respond virtually immediately to changes in the environment and user behavior, maintaining optimal performance. Further, the system can dynamically adapt to changing network conditions and user demands. For instance, in a densely populated area, the NPU can adjust beamforming parameters to minimize interference and maximize signal quality for each user. In contrast, in a rural area with fewer users, the NPU can optimize for longer range and energy efficiency. Still further, embedding AI models directly into the controller chip through the NPU allows for advanced functionalities such as predictive beamforming, where the system anticipates user movements and preadjusts signal paths based on the predictions, and intelligent resource allocation, where the system prioritizes certain applications to ensure reliable performance. At the same time, an NPU is known to have and is designed for low-power consumption, making it suitable for integration into wireless access points and other energy-sensitive applications. This reduces operational costs and supports the deployment of energy-efficient or battery-powered networks. The NPU-enhanced RIS controller can be scaled to accommodate various network architectures and deployment scenarios. Whether used in small indoor networks or large outdoor installations, the system can maintain high performance and efficiency.

Further benefits of an NPU include enhanced performance, in that an NPU can perform complex signal control functions more efficiently than general-purpose CPUs, leading to improved signal strength, coverage, and data throughput. This results in a better user experience with faster and more reliable connections. The system can dynamically adapt to network conditions, reducing latency and improving connection stability. This is particularly important in scenarios with high mobility or rapidly changing user densities.

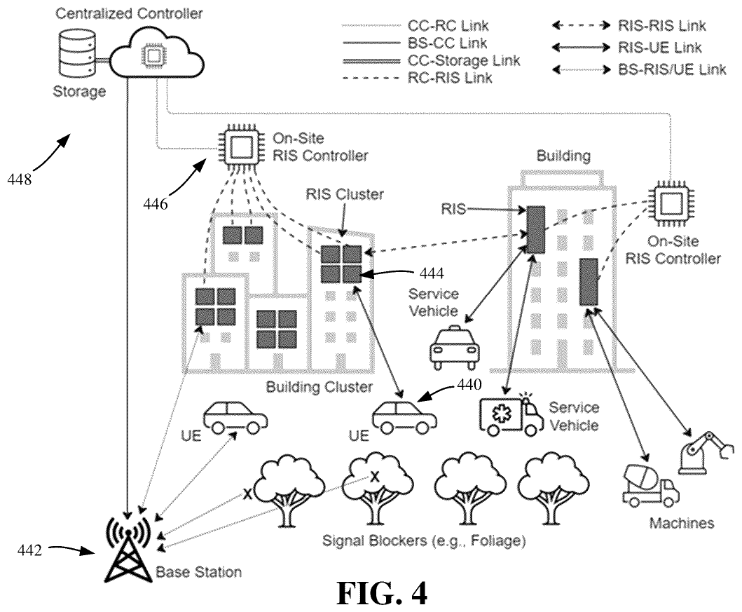

FIG. 4 shows an outdoor scenario where the signal from a base station is sometimes blocked by foliage, whereby on-site RIS controllers dynamically adjust the signal for consistent service quality. In terms of system context, in this example five types of entities define the system, namely endpoints (e.g., the user equipment 440 is one such endpoint), the base station 442, multiple active RISs (or simply defined as an RIS, e.g., 444), an on-site RIS controller 446, and a centralized controller 448. Consider that an endpoint (e.g., the user equipment 440) communicates with the base station 442 using THz signals, the base station 442 provides wireless access to the endpoint 440, the RIS 444 senses and manipulates the THz signals impinging on it, while the RIS controller 446 controls the RIS and communicates with the centralized controller 448. The centralized controller 448 further coordinates and optimizes the THz system using AI as described herein.

The example system operates by having each endpoint (e.g., the user equipment 440) send back the signal-to-interference-noise-ratio (SINR) on the uplink to the base station 442 for downlink connectors. The base station 442 forwards this SINR to the centralized controller 448, which monitors the THz system performance and detects any interference or noise issues.

The centralized controller 448 decides on RIS controller operation and forwards directives to the RIS controller 446, which acts as a communication, sense, and compute agent. The RIS 444 can sense the impinging signal and perform computations on it, such as filtering, amplifying, or splitting the impinging signal as described herein The RIS controller 446 can also configure the RIS 444 to reflect, refract, focus, or steer the incoming signal in the desired direction. For example, a field programmable gate array can be a controller connected through a digital-to-audio converter to an RIS panel, to provide the computed voltage data used to reconfigure the unit cells of the RIS to change the beam steering direction. Via constructive and destructive interference of signal portions redirected from the unit cells, the RIS arrays allow precise tuning of the redirected instances of the incoming electromagnetic (EM) waves.

As described herein, the RIS 444 and RIS controller 448 use GAN to learn the mapping from the received signal to the desired signal, and then generate signals that match the desired signal distribution. In one implementation, the RIS controller 446 modifies the THz signal according to the centralized controller 448 instructions, and then relays the signal to the RIS. The RIS further modifies the THz signal according to the centralized controller's instructions followed by relaying it to the endpoint 440. The endpoint 440 receives the modified signal, which has improved SINR (signal-to-interference-plus-noise ratio) and RSSI (received signal strength indicator relative to the non-modified signal.

To summarize, one example overall scenario shown in FIG. 4, RIS and RIS clusters are deployed on building facades connected using on-premises RIS controller regularly learning about the environment changes. The RIS controllers are being trained on real-time data, while the RIS controllers are driven by the centralized controller, which hosts a large language model (LLM), to receive updates from the RIS controllers. The on-the-fly compute happens in the RIS controllers. In the example scenario, the communication links to user equipment (UEs), service vehicles and machines are blocked by the foliage, and RIS panels or clusters installed on different buildings coordinate to maintain the service quality while learning about the environment to capture any interference. Based on the training, the RIS controllers offer interference mitigation or cancellation.

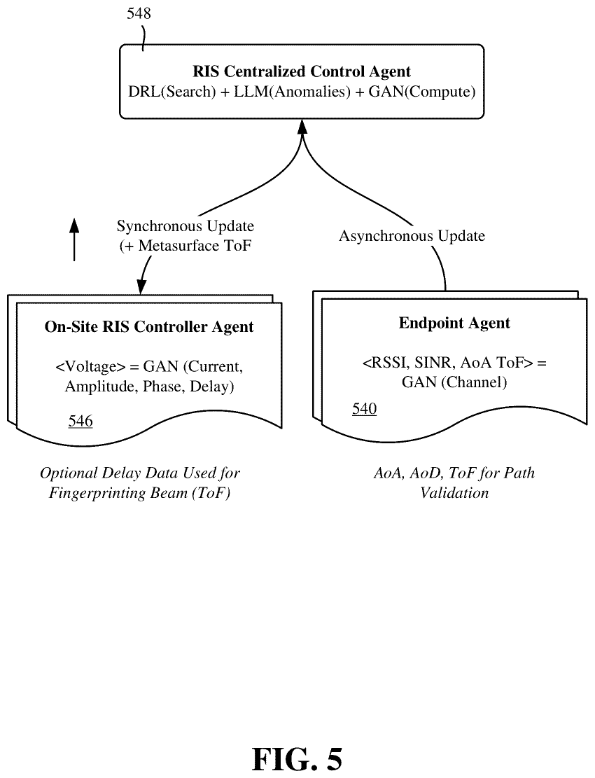

The end-to-end inferencing interplay of this approach is shown in FIG. 5. The RIS centralized controller (control agent 548) has the functionality of deep reinforcement learning (DRL) for searching and a LLM to capture anomalies early on the training or during the training phase. The cGAN is used by the RIS controller (on-side RIS controller agent 546) for compute. The centralized control agent 548 synchronously updates the on-site RIS controller agent 546. The RIS controller agent 546 obtains <Voltage> data for the tunable elements, and the GAN computes and optimizes for <Current, Amplitude, Phase, and Delay> of the EM signal. The endpoint agent 540 pushes asynchronous updates, and endeavors to maintain certain RSSI, SINR, AoA (angle-of-arrival), AoD (angle-of-departure), and ToF (time-of-flight) data, while the GAN computes the channel having the described variables. The AoA, AoD, and ToF information is used for path verification, while the <Delay> variable is used for fingerprinting the beam for security. In-case a secure protocol is not required, compute power can be saved by reducing the number of variables for GAN.

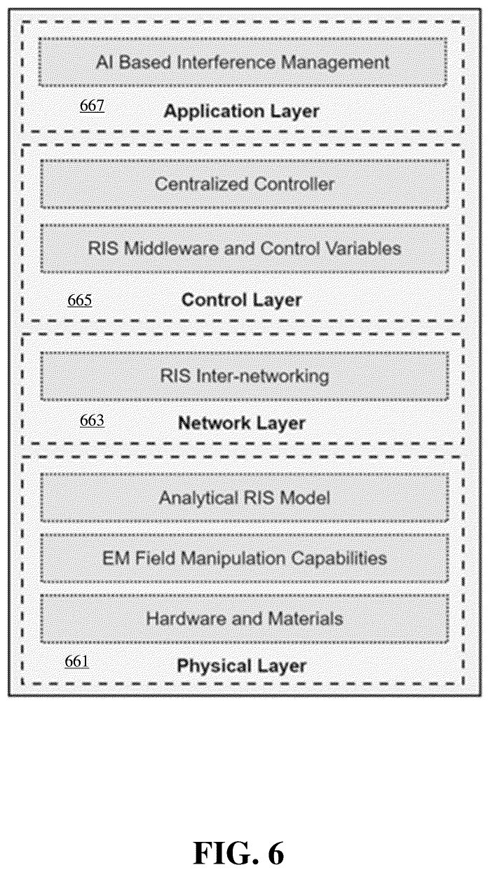

Example functionality layers are shown in FIG. 6, including a physical layer 661 including analytical RIS models, EM field manipulation capabilities, hardware, and materials. The network layer 663 includes RIS inter-networking between nearby modules in a cluster or from one RIS/RIS cluster to another RIS/RIS cluster. The control layer 665 is formed of an RIS controller and an RIS middleware module, while the application layer 667 is focused on interference management. NPU and AI processing capabilities can be included in the control layer, in one example implementation. In general, the physical layer 661 is configured for the hardware-based capabilities, while the control layer 665 and network layer 663 are more software/optimization oriented.

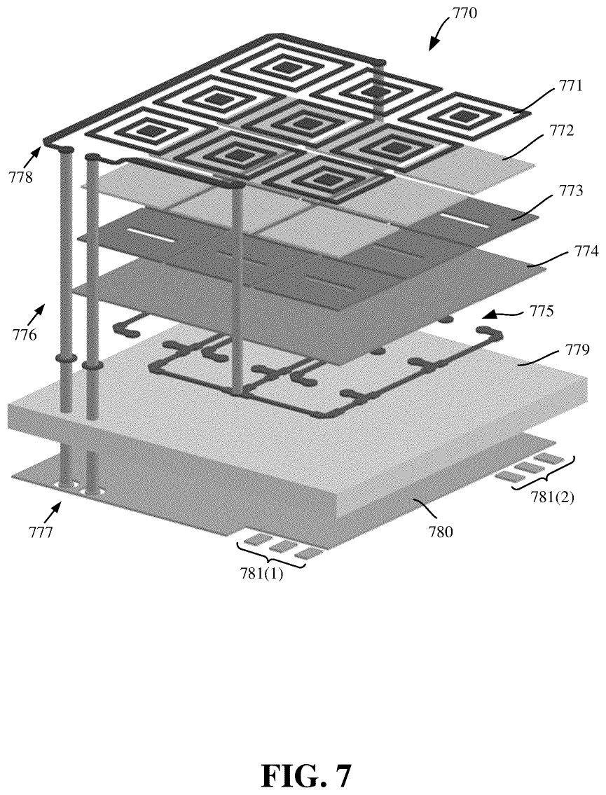

The unit cells of an RIS panel can be arranged as individual unit cells, or as subarray modules. For example, FIG. 7 depicts one non-limiting example implementation of a subarray 770 of (e.g., 3×3) unit cells that includes a number of layers, which are represented as separated in this exploded, perspective view representation. The technology is not restricted to any size subarray such as the nonlimiting nine unit cell example of FIG. 7, and for example can be scaled to a large number of unit cells, as long as the circuit or processing layer allows precise RF matching.

In general, a module is composed of a top layer consisting of resonators at appropriate (e.g., THz) frequencies; the resonators can be made of any shape or size as long as the unit-cells are at a sub-wavelength distance and resonate at a desired frequency. The metallization is not limited to any particular materials, such as aluminum, copper, gold, or silver, but rather any other conductive metal can be used to fabricate such elements. The second layer is an insulation or dielectric layer; nonlimiting examples of suitable materials include silicon dioxide, silicon nitride, alumina nitride, alumina oxide, or any other epoxy material. The layer next to the dielectric layer is for partial signal coupling made using a thin conductive metal with a slot. The module is designed such that the coupling is in one type of polarization only, either E- or V-polarization. An isolation layer underneath the partial signal coupling layer is similar to the dielectric layer with either similar materials mentioned above for the dielectric layer or slightly different material as long as it is non-conductive material.

The designer matches the impedance by selecting the dielectric constant or permittivity of the insulating materials. An RF/EM circuit layer beneath the isolation layer is made up of dual node-based signal pickup contacts such that only a portion of the signal is captured for digital read-out or processing. A 3×3 module is designed and matched such that the signal splitting will not create any RF mismatch and due to splitting enough signal is captured, combined, and recovered. The three-metal layer structure is built on the top side of a low-cost substrate such as silicon or alumina oxide. Bottom metallization under the substrate serves as the contact pads for digital connection with DAC and FPGA. Interconnects provide send and return signal path between top resonators and the processing circuit.

This is a non-limiting example and slight modifications such as addition or deletion of layers, building layers underneath the substrate, changing the materials will not create a separation.

In the particular example of FIG. 7, respective unit cells include electrically separated respective metallic resonating patterns (square shapes in this example, but of any suitable shape that can resonate at a desired, e.g., millimeter wave frequency), shown as resonators in a top layer 771. The next layer down is a first dielectric layer 772, with a metallic slotted plane layer 773 beneath the first dielectric layer 772. Note that individual (e.g., 3×3) dielectric parts in the layer 772 per unit cell resonator is depicted in this upper dielectric layer 772, such as to facilitate separate fabrication of each unit cell; however such an upper dielectric layer alternatively can be implemented as a single dielectric layer.

The metallic slotted plane layer 773 includes openings that facilitate RF (radio frequency) partial signal coupling, through an RF transparent insulator/isolation layer 774, to a RF/EM circuit layer 775. In one example implementation, the incoming RF signals are coupled through the slots to a first metallic microstrip line having respective terminals aligned with (one portion of) the respective slots, in which the first metallic microstrip line combines the incoming RF signals from each unit cell resonator, and couples the combined RF signals to a second metallic microstrip line, sometimes after signal modification as described herein. The second microstrip line redistributes the combined signals, through respective terminals aligned with (another portion of) the respective slots, back to their respective unit cell resonators through interconnect couplings, resulting in reflected instances of the incoming signals. As shown in FIG. 7, the microstrip lines of the circuit layer 775 are coupled through vias/interconnects 776, including for signal send/return 777 (for possible modification) through a return path 778. In general, the lengths of the paths add sufficient delay so that the incoming RF signals do not interfere with the reflected RF signals.

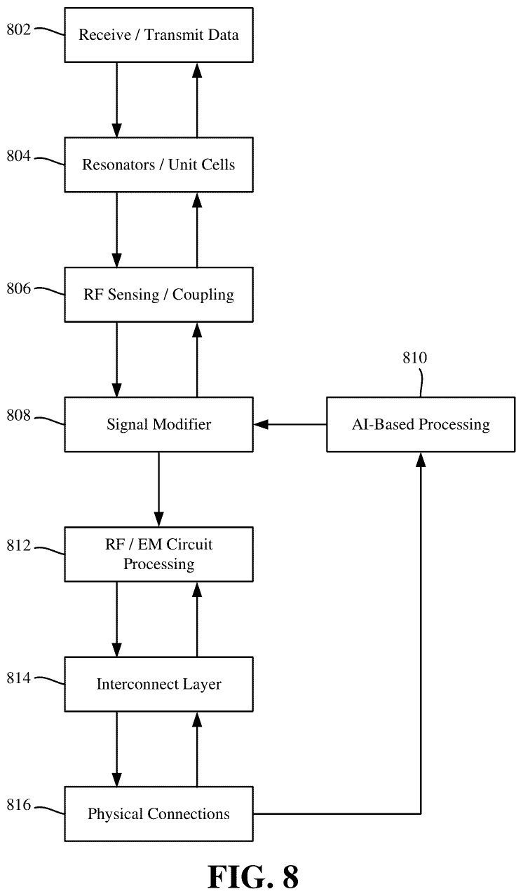

The components above and including the circuit layer 775 are supported on a dielectric substrate 779. A metallic ground plane 780 is primarily beneath the dielectric substrate 779. Contact terminals 781(1) and 781(2) facilitate coupling of the subarray to the tile controller and other circuitry, including for signal modification (distortion) as described with reference to FIG. 8.

To summarize, in one example implementation, a layout of the subarrays (e.g., modular) enables the design to be scalable to larger reconfigurable intelligent surface dimensions. In one example implementation, the subarray of unit cells has layered and integrated components, including four metal layers, namely a resonating patterns layer, a slotted plane layer for signal coupling, a microstrip network for signal combining and dividing, and a ground plane with a reserved area of terminals for coupling the subarray to circuitry. Between every two metal layers, there is an intervening layer of dielectric material. Such an architecture thus includes a passive signal coupling mechanism for processing and absorption of incoming signals can accomplish this without needing an active electronic component per subarray, thus saving significant power and contributing to carbon neutral footprints.

Signal processing within the RIS module is shown in FIG. 8. The top-most layer is used for receiving the signal illuminated on it or transmitting it back into the environment after processing. Unlike a typical RIS that does not involve signal processing within the module, one example implementation of the technology described herein offers an integrated module with such processing capability, as shown in FIG. 8.

The signal is illuminated on the surface which is received by the resonators, or an array of unit-cells followed by sensing or coupling the signal by the sensing layer. The signal processing modification occurs in the layer between the substrate and the isolation layer, where the portion of the received signal is read and used for training the on-site RIS controller. The controller computes the voltages that are usable to offset the phase. The rest of the variables adjusted to modify the signal, such as absorption, attenuation, filtering, or amplification, is decided by the AI compute module, which can be an NPU. The signal between the circuit layer, interconnect layer and physical connection creates a loop with the AI module in between for on-device processing and decision making. Keeping the compute and decision block on-device reduces the latency significantly and the mitigation techniques can be applied in an extremely short amount of time.

In the particular example of FIG. 8, block 802 represents the receiving and transmitting of the EM signals by the resonators/unit cells (block 804) of an RIS (also referred to as a metasurface). Block 806 represents the RF sensing/coupling through the signal coupling layer that includes the slots.

Blocks 808 and 810 represent signal modification as described herein. In particular, RF energy incident on the panel and partial energy is coupled through the slot aperture coupling panel; this partial energy can be used for processing and authentication. While awaiting processing/signal modification (block 808), which can be AI-based (block 810), the RIS can continue to redirect (e.g., reflect) non-modified signals.

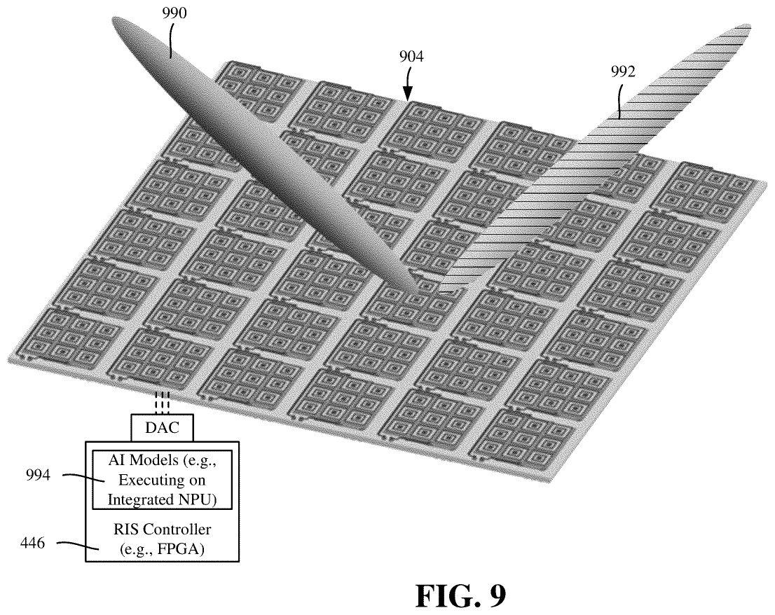

FIGS. 9-11 are three-dimensional (3D) views of an example RIS panel 904 highlight signal correction of an incident wave being reflected from an RIS panel of 18×18 unit cells arranged as a 6×6 modules of 3×3 subarray modules. Note that the thickness of the example panel is less than 0.5 mm, however the layers are shown as exploded in the 3D views to highlight the internals as in FIG. 7.

At an initial time t=tᵢₙᵢₜ, where tᵢₙᵢₜ includes propagation delay, circuit processing RC time constant and readout delay when an incident signal 990 is received by the RIS panel or module, with the signal having distortion and/or interference added. To avoid any blackout period, the modules keep reflecting the uncorrected signal until a mitigation decision is made by the integrated AI module in the controller as shown in FIG. 9 and described herein.

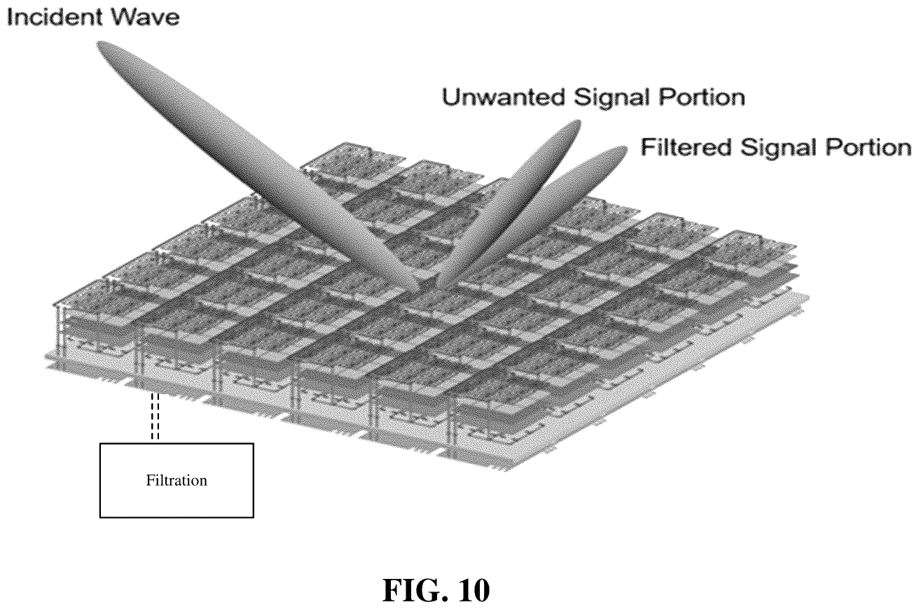

There is a transition phase at time t1=tᵢₙᵢₜ+d_{search}+d_{corrmech}, where d_{search} is the delay in searching for the correct relation between identified interference and d_{corrmech} is the delay associated with the correction mechanism including identification of the correction technique (e.g., attenuation, absorption, filtration, amplification, or the like). During the transition phase when the compute element (AI module) 994 (FIG. 9) is determining the correct mitigation technique, the reflected signal amplitude may reduce in strength as shown in FIG. 10. It is not expected to create communication blackout, but the amplitude may be affected for this period.

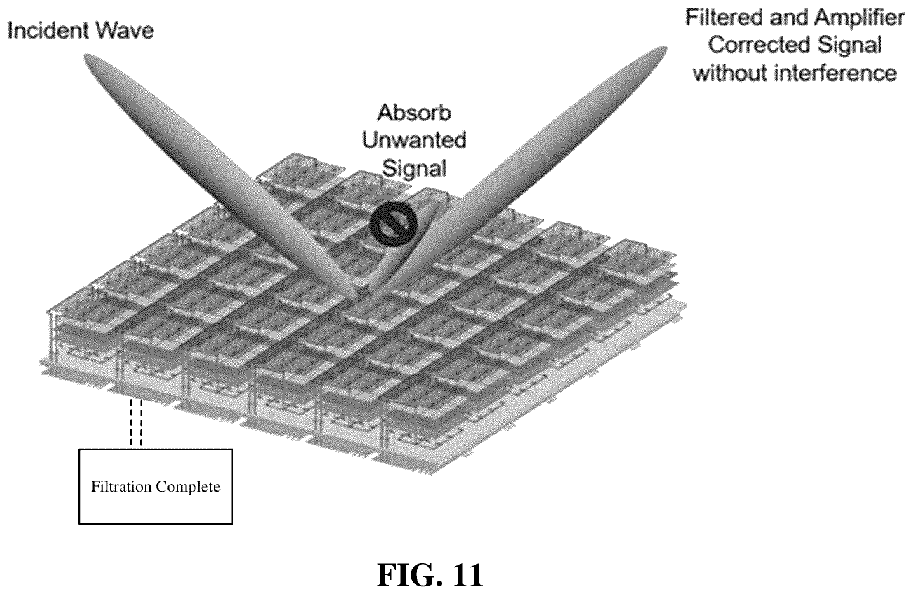

After successfully searching the correct interference pattern and applying the offset signal followed by mitigation technique (absorption in this case) as shown in FIG. 11, the filtered and corrected signal is amplified free from distortion. Thus, FIG. 11 represents signal redirection with distortion cancellation and amplifying the reflected signal without interference, along with absorption of the unwanted energy. If an integrated NPU in conjunction with a properly trained cGAN compute allows, the complete process can be done in less than a microsecond. Note that computing the cGAN variables using a limited set would speed up the mitigation.

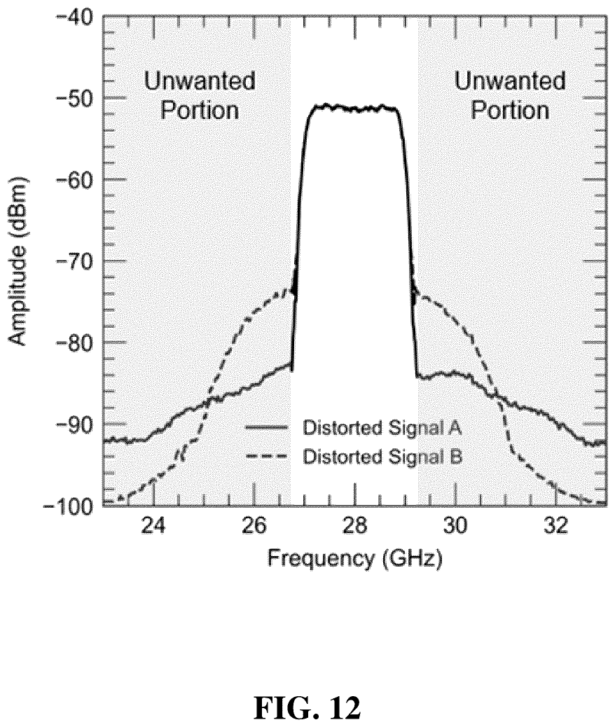

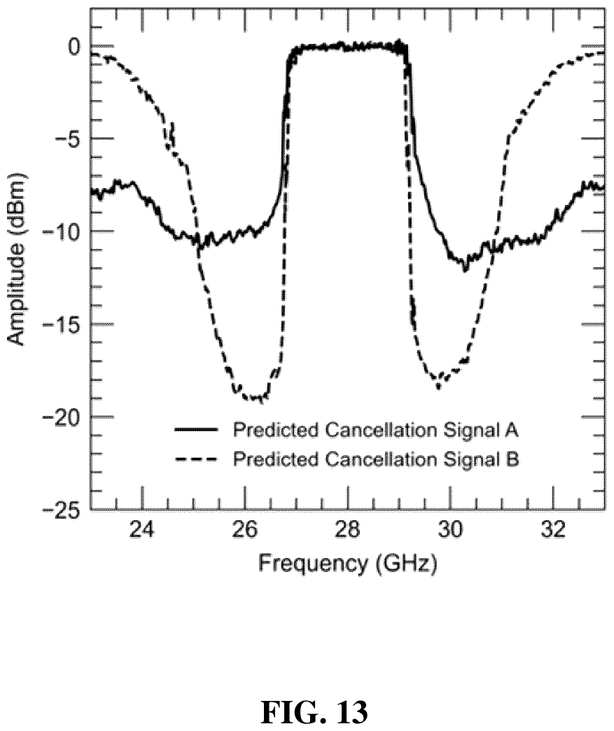

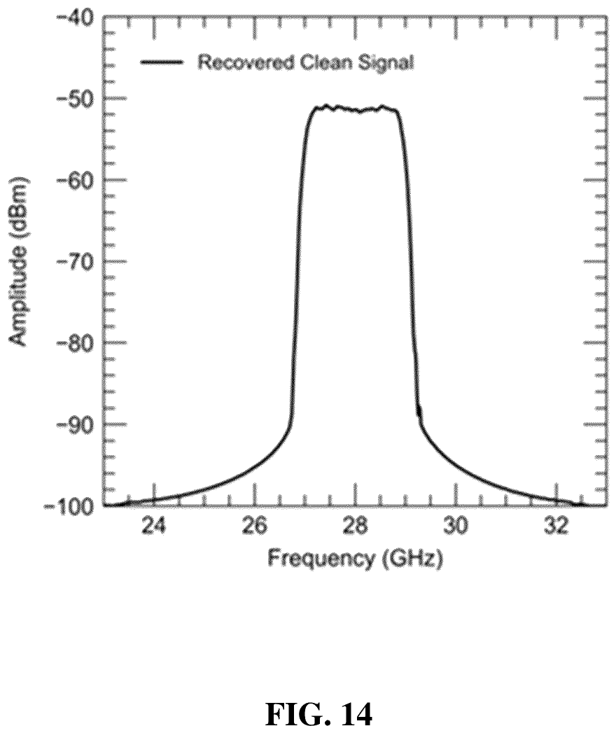

A real-life 28 GHz channel was simulated. Although the simulation is not at a THz band, the technique is frequency agnostic. The channel has 1 GHz bandwidth, and two different signals are incoming signals with distortion in the adjacent channels as shown in FIG. 12; the unwanted portions are shaded in the plot. The predicted interference offset signal is generated by the LLM (GAN compute in conjunction with DRL and LLM identifies the offset signal for the interference), and cGAN is applied to compute the correct variables to obtain the interference offset mitigation signal, as depicted in FIGS. 13 and 14, respectively. As can be seen from FIG. 14, the result is a filtered (recovered) clean signal after removing distortion.

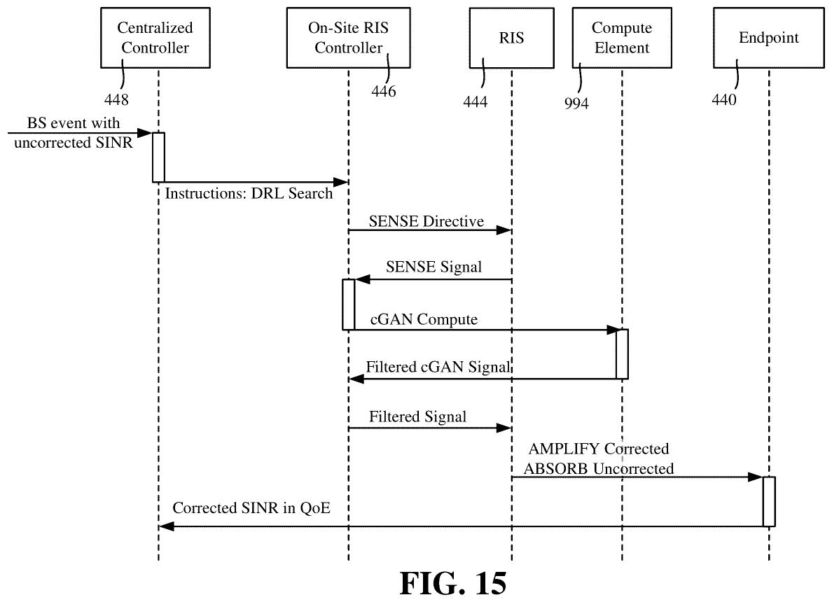

A sequence diagram is shown in FIG. 15, including the centralized controller 448 providing signal modification instructions (via a DRL search) to the RIS controller 446 for a base station (BS) event with uncorrected SINR. The RIS 444 in conjunction with the RIS controller (integrated or external) in this context can sense and compute the impinged signal, based on hardware support and power management. The compute element 994 returns the cGAN-filtered signal, which the RIS 444 then redirects to the endpoint 440.

The technology thus supports mapping out-of-range SINR signals to in-range SINR signals without a reference signal by levering GAN, by learning the mapping from received signal to the desired signal. GAN-based filtering thus provides interference and noise reduction. The system can leverage DRL in the centralized controller to manage the scheduling of RIS controller workload for scalability that helps keep the feedback loop latency to within few milliseconds. The technology benefits from hardware acceleration in an RIS controller with an FPGA that has an NPU for improved performance, which further keeps the control data on-device for enterprise level security.

High-frequency communication systems offer high data rates and low latency, but they are vulnerable to interference and noise from various sources, such as humans, pets, walls, furniture, and other devices. Active metasurfaces are reconfigurable surfaces that can manipulate the electromagnetic waves impinging on them, such as reflective, refracting, focusing, and splitting them. They can also sense the impinged signal and perform computation on the signal.

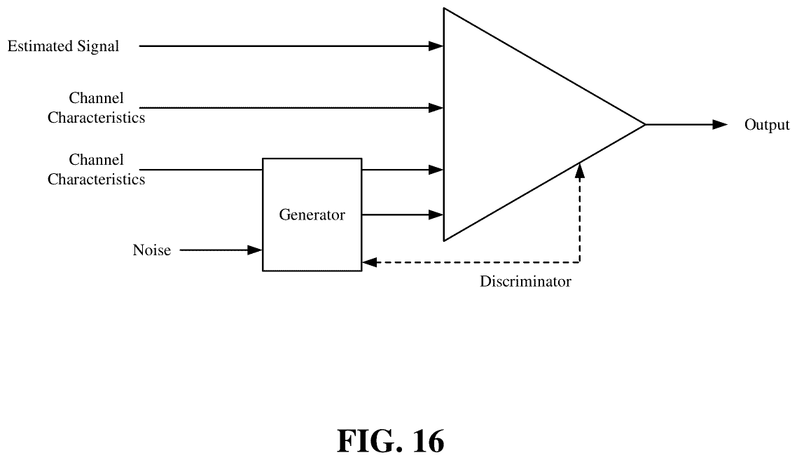

Training to filter data using cGAN is shown in FIG. 16. A GAN is a type of deep learning model that can generate realistic and high-quality data, such as images, audio, or text, by learning from a large dataset. As described herein, a GAN can be used to reduce the interference and noise in a millimeter wave or THz system by learning the mapping from the received signal to the desired signal, and then generating signals that match the desired signal distribution.

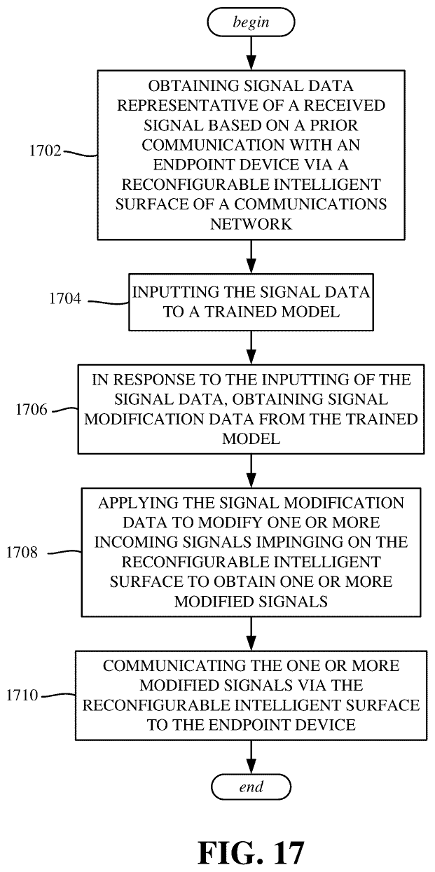

One or more implementations can be embodied in a system, such as represented in the example operations of FIG. 17, and for example can include at least one processor memory that stores computer executable components and/or operations, and at least one processor that executes computer executable components and/or operations stored in the memory. Example operations can include operation 1702, which represents obtaining signal data representative of a received signal based on a prior communication with an endpoint device via a reconfigurable intelligent surface of a communications network. Example operation 1704 represents inputting the signal data to a trained model. Example operation 1706 represents, in response to the inputting of the signal data, obtaining signal modification data from the trained model. Example operation 1708 represents applying the signal modification data to modify one or more incoming signals impinging on the reconfigurable intelligent surface to obtain one or more modified signals. Example operation 1710 represents communicating the one or more modified signals via the reconfigurable intelligent surface to the endpoint device.

The trained model can include a generative adversarial network model.

The trained model can include a conditional generative adversarial network model.

The signal can be one signal of a group of unmodified signals, and the reconfigurable intelligent surface can redirect at least part of the group of the unmodified signals until the signal modification data can be obtained.

The signal modification data can include at least one of: absorption data usable to modify an absorption of the one or more incoming signals, attenuation data usable to attenuate the one or more incoming signals, filtering data usable to filter one or more parts of the one or more incoming signals, or amplification data usable to amplify the one or more incoming signals.

The signal data can be representative of the signal being associated with distortion, obtaining the signal modification data can include obtaining signal correction data, and applying the signal modification data to the one or more incoming signals can include canceling at least part of the distortion to obtain the one or more modified signals. Canceling at least the part of the distortion can include filtering the one or more incoming signals into one or more respective modified signals, and one or more respective unwanted signals; the reconfigurable intelligent surface can redirect the one or more respective modified signals for the communicating of the one or more respective modified signals to the endpoint device, and can absorb one or more respective energies of the one or more respective unwanted signals.

The signal data can be representative of the signal being associated with interference, obtaining the signal modification data can include obtaining signal correction data, and applying the signal modification data to the one or more incoming signals can include canceling at least part of the interference to obtain the one or more modified signals. Canceling at least the part of the interference can include filtering the one or more incoming signals into one or more respective modified signals, and one or more respective unwanted signals; the reconfigurable intelligent surface can redirect the one or more respective modified signals for the communicating of the one or more respective modified signals to the endpoint device, and absorb one or more respective energies of the one or more respective unwanted signals.

The reconfigurable intelligent surface can include an array of unit cells divided into respective subarray modules of unit cells, and the respective subarray modules can include respective signal processing devices that execute respective instances of the trained model to obtain respective signal modification datasets corresponding to the respective subarray modules. The respective signal modification datasets can include at least one of: respective absorption data usable to modify an absorption of at least one of the one or more incoming signals, respective attenuation data usable to attenuate the at least one of the one or more incoming signals, respective filtering data usable to filter the at least one of the one or more incoming signals, or respective amplification data usable to amplify the at least one of the one or more incoming signals.

The trained model can be executed via a neural processing unit coupled to a controller of the reconfigurable intelligent surface, and the trained model can be updated by a centralized controller coupled to the controller.

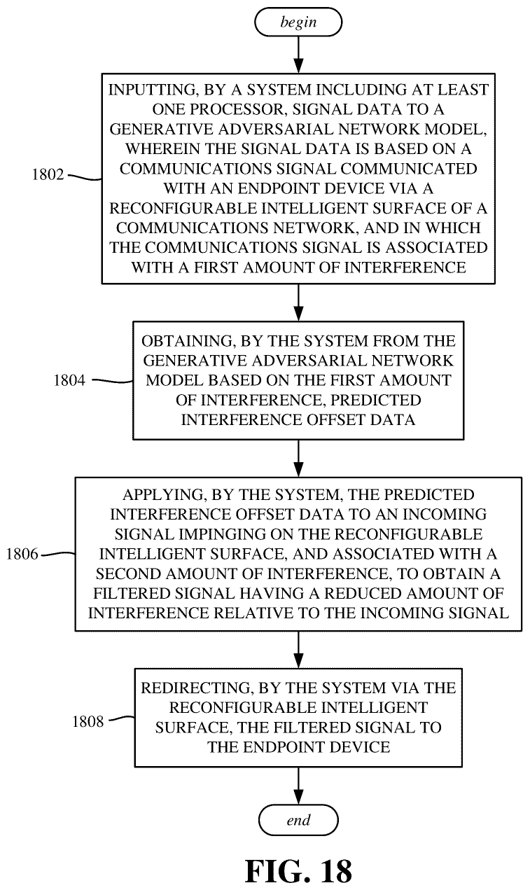

One or more example implementations and embodiments, such as corresponding to example operations of a method, can be represented in FIG. 18. Example operation 1802 represents inputting, by a system including at least one processor, signal data to a generative adversarial network model, wherein the signal data can be based on a communications signal communicated with an endpoint device via a reconfigurable intelligent surface of a communications network, and in which the communications signal can be associated with a first amount of interference. Example operation 1804 represents obtaining, by the system from the generative adversarial network model based on the first amount of interference, predicted interference offset data. Example operation 1806 represents applying, by the system, the predicted interference offset data to an incoming signal impinging on the reconfigurable intelligent surface, and associated with a second amount of interference, to obtain a filtered signal having a reduced amount of interference relative to the incoming signal. Example operation 1802 represents redirecting, by the system via the reconfigurable intelligent surface, the filtered signal to the endpoint device.

The filtered signal can correspond to the incoming signal having removed energy corresponding to the amount of interference; further operations can include absorbing or substantially absorbing, by the system, the removed energy.

Further operations can include amplifying, by the system, the filtered signal prior to the redirecting of the filtered signal to the endpoint device.

Further operations can include executing the generative adversarial network model in a signal processing layer associated with at least one unit cell of the reconfigurable intelligent surface.

The incoming signal impinging on the reconfigurable intelligent surface can be part of a group of incoming signals impinging on the reconfigurable intelligent surface over time, and further operations can include redirecting, by the system, the group of incoming signals to the endpoint device until the filtered signal can be obtained.

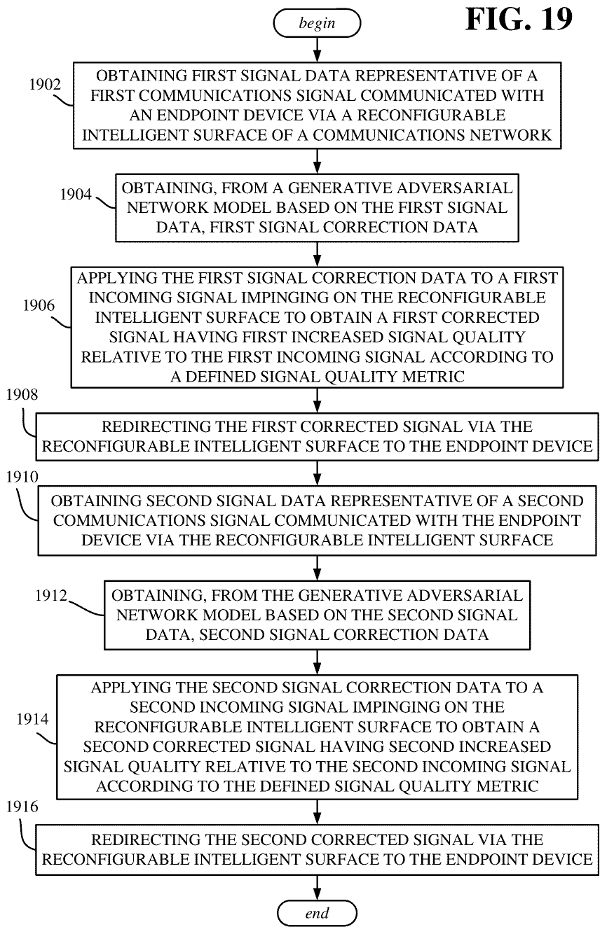

FIG. 19 summarizes various example operations, e.g., corresponding to a machine-readable medium, comprising executable instructions that, when executed by at least one processor of network equipment, facilitate performance of operations. Example operation 1902 represents obtaining first signal data representative of a first communications signal communicated with an endpoint device via a reconfigurable intelligent surface of a communications network. Example operation 1904 represents obtaining, from a generative adversarial network model based on the first signal data, first signal correction data. Example operation 1906 represents applying the first signal correction data to a first incoming signal impinging on the reconfigurable intelligent surface to obtain a first corrected signal having first increased signal quality relative to the first incoming signal according to a defined signal quality metric. Example operation 1908 represents redirecting the first corrected signal via the reconfigurable intelligent surface to the endpoint device. Example operation 1910 represents obtaining second signal data representative of a second communications signal communicated with the endpoint device via the reconfigurable intelligent surface.

Example operation 1912 represents obtaining, from the generative adversarial network model based on the second signal data, second signal correction data. Example operation 1914 represents applying the second signal correction data to a second incoming signal impinging on the reconfigurable intelligent surface to obtain a second corrected signal having second increased signal quality relative to the second incoming signal according to the defined signal quality metric. Example operation 1916 represents redirecting the second corrected signal via the reconfigurable intelligent surface to the endpoint device.

The first corrected signal can result in an unwanted signal portion, and the further operations can include absorbing the unwanted signal portion.

Further operations can include amplifying the first corrected signal to the redirecting of the first corrected signal to the endpoint device.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit, and scope in accordance with the appended claims.

What is claimed is:

1. A system, comprising:
at least one processor; and
at least one memory that stores executable instructions that, when executed by the at least one processor, facilitate performance of operations, the operations comprising:
obtaining signal data representative of a received signal based on a prior communication with an endpoint device via a reconfigurable intelligent surface of a communications network;
inputting the signal data to a trained model;
in response to the inputting of the signal data, obtaining signal modification data from the trained model;
applying the signal modification data to modify one or more incoming signals impinging on the reconfigurable intelligent surface to obtain one or more modified signals; and
communicating the one or more modified signals via the reconfigurable intelligent surface to the endpoint device.

2. The system of claim 1, wherein the trained model comprises a generative adversarial network model.

3. The system of claim 1, wherein the trained model comprises a conditional generative adversarial network model.

4. The system of claim 1, wherein the signal is one signal of a group of unmodified signals, and wherein the reconfigurable intelligent surface redirects at least part of the group of the unmodified signals until the signal modification data is obtained.

5. The system of claim 1, wherein the signal modification data comprises at least one of: absorption data usable to modify an absorption of the one or more incoming signals, attenuation data usable to attenuate the one or more incoming signals, filtering data usable to filter one or more parts of the one or more incoming signals, or amplification data usable to amplify the one or more incoming signals.

6. The system of claim 1, wherein the signal data is representative of the signal being associated with distortion, wherein the obtaining of the signal modification data comprises obtaining signal correction data, and wherein the applying of the signal modification data to the one or more incoming signals comprises canceling at least part of the distortion to obtain the one or more modified signals.

7. The system of claim 6, wherein the canceling of at least the part of the distortion comprises filtering the one or more incoming signals into one or more respective modified signals, and one or more respective unwanted signals, and wherein the reconfigurable intelligent surface:
redirects the one or more respective modified signals for the communicating of the one or more respective modified signals to the endpoint device, and
absorbs one or more respective energies of the one or more respective unwanted signals.

8. The system of claim 1, wherein the signal data is representative of the signal being associated with interference, wherein the obtaining of the signal modification data comprises obtaining signal correction data, and wherein the applying of the signal modification data to the one or more incoming signals comprises canceling at least part of the interference to obtain the one or more modified signals.

9. The system of claim 8, wherein the canceling of at least the part of the interference comprises filtering the one or more incoming signals into one or more respective modified signals, and one or more respective unwanted signals, and wherein the reconfigurable intelligent surface:
redirects the one or more respective modified signals for the communicating of the one or more respective modified signals to the endpoint device, and
absorbs one or more respective energies of the one or more respective unwanted signals.

10. The system of claim 1, wherein the reconfigurable intelligent surface comprises an array of unit cells divided into respective subarray modules of unit cells, and wherein the respective subarray modules comprise respective signal processing devices that execute respective instances of the trained model to obtain respective signal modification datasets corresponding to the respective subarray modules.

11. The system of claim 9, wherein the respective signal modification datasets comprise at least one of: respective absorption data usable to modify an absorption of at least one of the one or more incoming signals, respective attenuation data usable to attenuate the at least one of the one or more incoming signals, respective filtering data usable to filter the at least one of the one or more incoming signals, or respective amplification data usable to amplify the at least one of the one or more incoming signals.

12. The system of claim 1, wherein the trained model is executed via a neural processing unit coupled to a controller of the reconfigurable intelligent surface, and wherein the trained model is updated by a centralized controller coupled to the controller.

13. A method, comprising:
inputting, by a system comprising at least one processor, signal data to a generative adversarial network model, wherein the signal data is based on a communications signal communicated with an endpoint device via a reconfigurable intelligent surface of a communications network, and wherein the communications signal is associated with a first amount of interference;
obtaining, by the system from the generative adversarial network model based on the first amount of interference, predicted interference offset data;
applying, by the system, the predicted interference offset data to an incoming signal impinging on the reconfigurable intelligent surface, and associated with a second amount of interference, to obtain a filtered signal having a reduced amount of interference relative to the incoming signal; and
redirecting, by the system via the reconfigurable intelligent surface, the filtered signal to the endpoint device.

14. The method of claim 13, wherein the filtered signal corresponds to the incoming signal having removed energy corresponding to the amount of interference, further comprising absorbing or substantially absorbing, by the system, the removed energy.

15. The method of claim 13, further comprising amplifying, by the system, the filtered signal prior to the redirecting of the filtered signal to the endpoint device.

16. The method of claim 13, further comprising executing the generative adversarial network model in a signal processing layer associated with at least one unit cell of the reconfigurable intelligent surface.

17. The method of claim 13, wherein the incoming signal impinging on the reconfigurable intelligent surface is part of a group of incoming signals impinging on the reconfigurable intelligent surface over time, and further comprising redirecting, by the system, the group of incoming signals to the endpoint device until the filtered signal is obtained.

18. A non-transitory machine-readable medium, comprising executable instructions that, when executed by at least one processor of network equipment, facilitate performance of operations, the operations comprising:
obtaining first signal data representative of a first communications signal communicated with an endpoint device via a reconfigurable intelligent surface of a communications network;
obtaining, from a generative adversarial network model based on the first signal data, first signal correction data;
applying the first signal correction data to a first incoming signal impinging on the reconfigurable intelligent surface to obtain a first corrected signal having first increased signal quality relative to the first incoming signal according to a defined signal quality metric;
redirecting the first corrected signal via the reconfigurable intelligent surface to the endpoint device;
obtaining second signal data representative of a second communications signal communicated with the endpoint device via the reconfigurable intelligent surface;
obtaining, from the generative adversarial network model based on the second signal data, second signal correction data;
applying the second signal correction data to a second incoming signal impinging on the reconfigurable intelligent surface to obtain a second corrected signal having second increased signal quality relative to the second incoming signal according to the defined signal quality metric; and
redirecting the second corrected signal via the reconfigurable intelligent surface to the endpoint device.

19. The non-transitory machine-readable medium of claim 18, wherein the first corrected signal results in an unwanted signal portion, and wherein the operations further comprise absorbing the unwanted signal portion.

20. The non-transitory machine-readable medium of claim 18, wherein the operations further comprise amplifying the first corrected signal to the redirecting of the first corrected signal to the endpoint device.
